(19) United States
(12) Patent Application Publication
(10) Pub. No.: US 2006/0108153 A1
(43) Pub. Date: May 25, 2006

(54) Device for measuring load in a vehicle

(76) Inventors: Michael Munz, Reutlingen (DE); Frank Fischer, Gomaringen (DE); Gottfried Flik, Leonberg (DE)

Correspondence Address: KENYON & KENYON LLP, ONE BROADWAY, NEW YORK, NY, 10004, US

(21) Appl. No.: 10/520,559

(22) PCT Filed: Feb. 25, 2003
(86) PCT No.: PCT/DE03/00588

§ 371 Date: Aug. 16, 2005

(30) Foreign Application Priority Data
Jul. 17, 2002 (DE) 102 32 360.7

(51) Int. Cl. G01G 19/08; G01H 5/00; G01G 3/16; B60T 7/14; B60R 21/16

(52) U.S. Cl. 177/136; 177/137; 177/210 R; 180/273; 280/735; 177/144; 73/580; 73/597

(57) ABSTRACT

A device for measuring weight in a vehicle includes an expansion unit which becomes elongated under the influence of the weight being measured, and a sensor system which determines the elongation through a transit time measurement. Ultrasonic pulses are used for the transit time measurement.

### FIELD OF THE INVENTION

The present invention relates to a device for measuring weight in a vehicle.

### BACKGROUND INFORMATION

Published German patent document DE 199 48 045 discloses a device for measuring weight in a vehicle, in which device strain gauges are used and the weight is determined through the elongation of the strain gauge.

### SUMMARY

The device according to the present invention for measuring weight in a vehicle has the advantage over the related art that the elongation, and thus the weight, is determined using a transit time measurement, rather than through a change in electrical variables, as in the case of a strain gauge. In accordance with the invention, transit time differences are determined using ultrasonic pulses. Compact sensors may be used for the transit time measurement. Furthermore, measurement of the force distribution is possible. The analysis system may be of robust design. The device according to the present invention and the sensor measuring principle are adapted for self-testing and economical.

Particularly advantageous is the fact that the sensor system for transit time measurement uses mechanical waves.

Mechanical waves are able to propagate in particular on solid bodies, but also in liquids or gases, and are reflected at separation layers, and thus make simple determination of the elongation possible through transit time differences.

It is also advantageous that ultrasonic waves are used as the mechanical waves. Ultrasonic waves allow a particularly sensitive measurement of small elastic elongations. Steel bodies may be measured therewith particularly precisely in regard to their elongation. The pulse echo method may be used to that end. The ultrasonic frequencies are generated, for example, in a range around 15 MHz, and are then injected into the expansion unit. The wave propagates longitudinally and transversely, and is reflected for example by the end surface of the expansion unit. The transit time difference between transmitted and received pulses is measured, hence the designation of pulse echo method. The pulse frequency may be between 500 Hz and 5000 Hz. The change in transit time difference is the measure of the elongation of the bolt, and thus of the weight that is being measured.

For ultrasonic measurement, an ultrasonic probe is provided on the vehicle seat, which may be coupled mechanically with a seat element, so that the gravitational force is transferred to the ultrasonic probe and causes the elongation of the ultrasonic probe. This elongation may be the result of bending or torsion. The ultrasonic probe may be placed in seat mountings. The seat element may form at least in part the seat surface or the backrest.

### BRIEF DESCRIPTION OF THE DRAWINGS

FIG. 1 shows a schematic representation that illustrates the transfer of the sitting force to an elongation of an ultrasonic probe according to an example embodiment.

FIG. 2 shows a schematic representation that illustrates the transfer of the sitting force to torsion of an ultrasonic probe according to another example embodiment.

FIG. 3 shows a top view illustrating the transfer of the sitting force to torsion of an ultrasonic probe, i.e., in the direction of the force impact.

### DETAILED DESCRIPTION

To determine seat occupancy in vehicles, sensors are used to determine the sitting force on the individual seats. Heretofore, sensors based on strain gauges have been used for this purpose. Seat mat sensors are also known, a change in electrical variables being in all cases changed to an elongation.

According to the present invention, this elongation is determined through transit time differences, e.g., measured using ultrasonic pulses. This results in a robust measuring method, which is capable of self-testing, allows simple measurement of the force distribution, and facilitates the use of compact probes.

This requires a sensor system that is able to measure an elastic elongation sensitively. An example embodiment of an expansion unit includes a component made of steel having an integrated ultrasonic transmitter. A piezoelectric layer, made for example of zinc oxide, aluminum nitride or PZT, is applied to the expansion unit as an elastic body. The deposition is accomplished using physical methods, such as a plasma gaseous phase deposition (PVD=plasma vapor deposition). On top of the piezoelectric layer a metal layer is applied, structured for example using shadow masks or photolithography, which functions as an electrode.

To measure the elongation of the expansion unit, a high frequency in the range of 15 MHz, for example, is injected into the piezoelectric layer through the metal contact. A mechanical wave (ultrasound) is thereby injected into the expansion unit. The wave propagates in the expansion unit as a longitudinal and transverse wave, and is reflected for example by the end surface of the expansion unit. The transit time difference between transmitted and received pulses is measured—this is the pulse echo method—, with a frequency of around 500 Hz to 5000 Hz being used. The change in the transit time difference is a measure of an elongation of the expansion unit, and thus of the weight that has been placed on the seat.

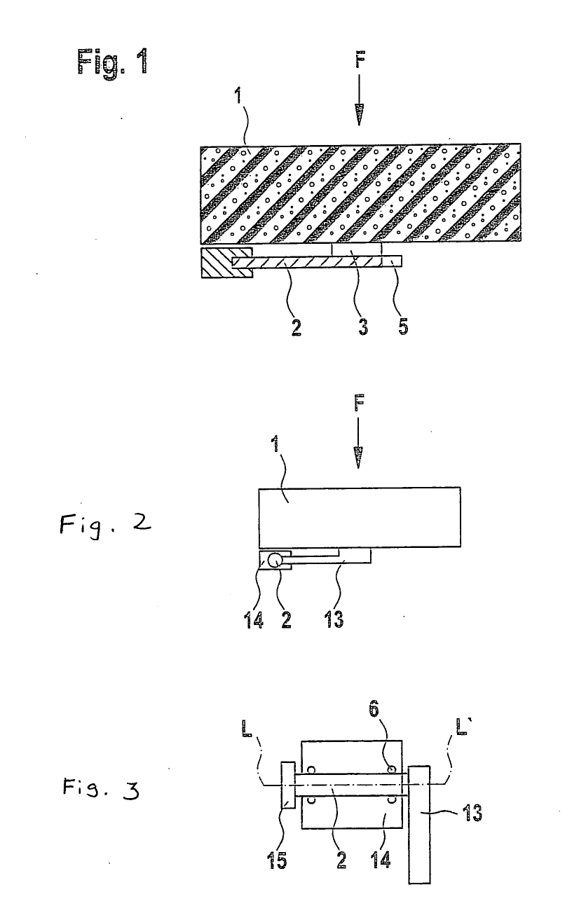

FIG. 1 shows schematically the transfer of the sitting force to an elongation of an ultrasonic probe. Sitting force F is applied here to the center of a seat element 1. Beneath seat element 1 is an ultrasonic probe 2, which also has for example lateral reflector notches. This ultrasonic probe 2 is coupled to seat element 1 through a mechanical coupling 3. In addition, ultrasonic probe 2 is held firmly in place by a mechanical suspension, e.g., a fixed bearing, having an electrical trigger unit of the ultrasonic probe at its other end. Alternatively, it is possible to also provide an electrical trigger unit in area 5 of ultrasonic probe 2. In addition, it is possible for ultrasonic probe 2 to be firmly clamped at a plurality of places.

Sitting force F is passed on to ultrasonic probe 2 through mechanical connection 3. Ultrasonic probe 2 is elongated or compressed by bending. Ultrasonic probe 2 is thus used as an expansion unit. The uniaxial bending in the direction of force F may be evaluated using the pulse echo method, as described above. To that end, ultrasonic pulses are generated by an ultrasonic transmitter and injected into ultrasonic probe 2, which is made of steel, for example. The transit time differences between the coupled and received pulses is measured. Through this transit time difference, the length of the probe is measurable, and thus also its elongation in comparison to the normal length. The transit time measurement is performed at 15 MHz, for example. A pulse repetition frequency of 1 KHz may be used. A range of 500 Hz to 5 KHz may be used. It is possible to determine transit time measuring values to a precision of 100 picoseconds. Electrical trigger unit 5 has a plausibility algorithm which ensures that out of 1000 measured values 500 precise and error-free values are transmitted to the controller.

FIG. 2 shows another schematic representation, in which sitting force F is transferred to a torsion of ultrasonic probe 2. To that end, there is a different mechanical coupling 13 between seat element 1 and ultrasonic probe 2. In addition, a mechanical guide 14 for the torsion is provided at the other end of the ultrasonic probe. The mechanical coupling between ultrasonic probe 2 and seat element 1 is embodied here in a sort of crossbar, so that force F results in a rotary motion on ultrasonic probe 2 via mechanical coupling 3; mechanical guide 14 contributes to this motion.

FIG. 3 shows in a top view an example embodiment of the system for transferring the sitting force to a torsion of ultrasonic probe 2. The top view shows the system in the direction of the force impact. Sitting force F is represented accordingly, the axis of torsion being indicated by the line defined by L and L′. An axle bearing 6 around ultrasonic probe 2, as well as mechanical coupling 13 and mechanical guide 14 are provided to convert the force impact into a torsion acting on the ultrasonic probe. A mechanical clamping system 15 having electrical tensioning of ultrasonic probe 2 is also provided for this torsion probe.

In addition to the above example embodiments, there are additional alternatives for converting sitting force F into an elongation of an ultrasonic probe. Through locally applied ultrasonic probes, it is possible to measure the distribution of the sitting force over the seat surface and backrest. The possibility also exists, for example, of integrating ultrasonic probe 2 directly into the seat mountings.

1-8. (canceled)

9. A device for measuring weight, comprising:
an expansion unit configured to be elongated under the influence of the weight; and
a sensor system for measuring a degree of elongation of the expansion unit, wherein the degree of elongation is determined based on a transit time of a measuring wave within the expansion unit.

10. The device as recited in claim 9, wherein the measuring wave is a mechanical wave.

11. The device as recited in claim 10, wherein the mechanical wave is in the ultrasonic range.

12. The device as recited in claim 9, wherein the sensor system uses a pulse echo method to measure the transit time.

13. The device as recited in claim 11, wherein the expansion unit is an ultrasonic probe provided on a vehicle seat, wherein the ultrasonic probe is adapted to be coupled mechanically with an element of the vehicle seat.

14. The device as recited in claim 13, wherein the ultrasonic probe is configured to be distorted by at least one of bending and torsion.

15. The device as recited in claim 14, wherein the ultrasonic probe is located in a seat mounting.

16. The device as recited in claim 13, wherein the element of the seat is at least a part of one of the seat surface and the backrest.
